(19) United States
(12) Patent Application Publication
(10) Pub. No.: US 2014/0061526 A1
(43) Pub. Date: Mar. 6, 2014

(54) DIAPHRAGM VALVE

(71) Applicant: Fujikin Incorporated, Osaka-shi (JP)

(72) Inventors: Kazunari Watanabe, Osaka-shi (JP); Izuru Shikata, Osaka-shi (JP)

(73) Assignee: Fujukin Incorporated, Osaka-shi (JP)

(21) Appl. No.: 14/012,100

(22) Filed: Aug. 28, 2013

(30) Foreign Application Priority Data
Aug. 31, 2012 (JP) 2012-191270

(51) Int. Cl. F16K 7/12

(52) U.S. Cl. CPC F16K 7/12
USPC 251/331

(57) ABSTRACT

A fluid inflow passage 3 is made up of an inner communication portion 11 having an upper end opening that leads to a center portion of a bottom surface of a recess 5 in a body and a lower end surface that is closed and an outer communication portion 12 having one end that leads to the inner communication portion 11 and the other end that forms a fluid inlet. The inner communication portion 11 has a column-like protruding portion 13 provided on the lower end surface 11a so as to form a column-like non-passage portion in the inner communication portion and thereby forms a cylindrical-hollow passage. It thus becomes possible to provide a diaphragm valve 1 with which a Cv value can be increased without increasing an outer shape.

### FIELD OF THE INVENTION

The present invention relates to a diaphragm valve.

### BACKGROUND ART

There is a diaphragm valve using a diaphragm as a valve element and such a diaphragm valve is described, for example, in JP-A-2006-90386.

FIG. 3 shows a major portion of a diaphragm valve in the related art. Referring to FIG. 3, a diaphragm valve 31 includes a body 32 provided with a fluid inflow passage 33, a fluid outflow passage 34, and a recess 35 opening upward, a ring-like sheet 36 disposed on a bottom surface of the recess 35 in the body 32, a diaphragm 37 that opens and closes the fluid inflow passage 33, respectively, when pressed against and spaced apart from the sheet 36, an inlet-side joint portion 38, and an outlet-side joint portion 39.

The fluid inflow passage 33 has an L-shaped vertical cross section and is made up of a column-like inner communication portion 33a having an upper end opening that leads to a center portion of the bottom surface of the recess 35 in the body 32 and a column-like outer communication portion 33b having one end that leads to the inner communication portion 33a and the other end that forms a fluid inlet.

For the diaphragm valve 31 in the related art to increase a flow coefficient (Cv value), it is generally necessary to increase an outer shape of the diaphragm valve 31. In other words, the flow coefficient (Cv value) can be increased by increasing a diameter of the inner communication portion 33a making up the fluid inflow passage 33 and it is difficult to increase the Cv value without increasing the outer shape.

### SUMMARY OF THE INVENTION

An object of the invention is to provide a diaphragm valve with which the Cv value can be increased without increasing the outer shape.

A diaphragm valve of the invention includes; a body provided with a fluid inflow passage, a fluid outflow passage, and a recess opening upward; a ring-like sheet disposed on a bottom surface of the recess in the body; and an elastically deformable diaphragm that opens and closes the fluid passages, respectively, when pressed against and spaced apart from the sheet. The fluid inflow passage is made up of an inner communication portion having an upper end opening that leads to a center portion of the bottom surface of the recess in the body and a lower end surface that is closed and an outer communication portion having one end that leads to the inner communication portion and the other end that forms a fluid inlet. The inner communication portion has a column-like protruding portion provided on the lower end surface so as to form a column-like non-passage portion in the inner communication portion and thereby forms a cylindrical-hollow passage.

In a diaphragm valve in the related art, both the inner communication portion and the outer communication portion that together make up the fluid inflow passage are of a column shape. Contrary to this configuration, the diaphragm valve of the invention is configured in such a manner that the inner communication portion making up the fluid inflow passage is of a cylinder hollow shape. This cylindrical-hollow passage is formed by providing a column-like protruding portion on the lower end surface of the inner communication portion. By being formed in a cylinder hollow shape in this manner, the inner communication portion can have an increased opening area in comparison with the column-like inner communication portion in the related art . It thus becomes possible to increase the Cv value without increasing the outer shape of the diaphragm valve.

It is preferable that an upper surface of the column-like protruding portion is a diaphragm support surface that prevents the diaphragm from undergoing a deflection excessively.

The diaphragm valve can be a manual valve in which a moving up-and down means is an opening and closing handle or an automatic valve in which the moving up-and-down means is a suitable actuator. In the case of an automatic valve, the actuator can be operated by a fluid (air) pressure or an electromagnetic force.

In the specification, a direction of deformation of the diaphragm is defined as a top-bottom direction. It should be appreciated, however, that this direction is defined for ease of description and the top-bottom direction in actual attachment can be either a vertical direction or a horizontal direction.

According to the diaphragm valve of the invention, by forming the inner communication portion making up the fluid inflow passage in a cylinder hollow shape, an opening area of the inner communication portion can be increased in comparison with an opening area of the column-like inner communication portion. It thus becomes possible to increase the Cv value without increasing the outer shape of the diaphragm valve.

### BRIEF DESCRIPTION OF THE DRAWINGS

FIG. 1 is a longitudinal cross section showing one embodiment of a diaphragm valve of the invention;

FIG. 2 is a perspective view showing a major portion of FIG. 1; and

FIG. 3 is a longitudinal cross section showing a diaphragm valve in the related art.

### DESCRIPTION OF THE PREFERRED EMBODIMENT

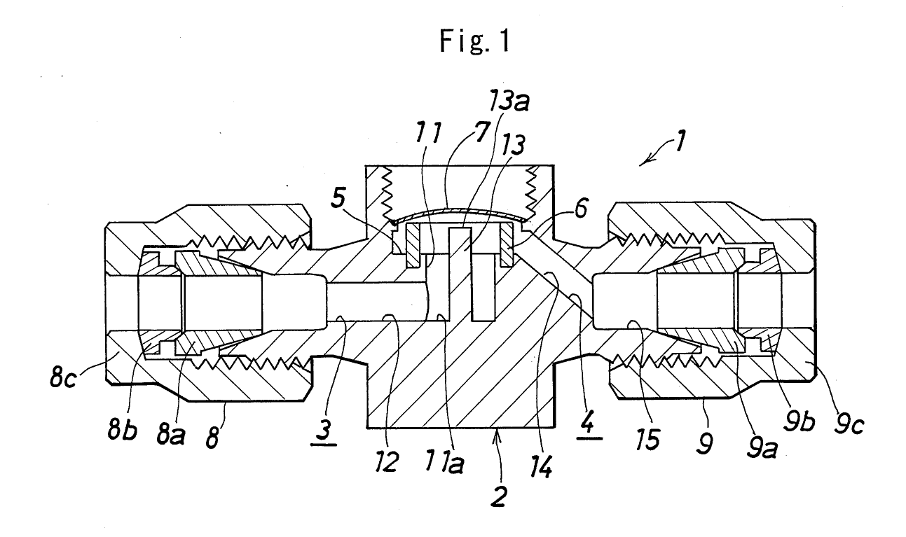

Hereinafter, one embodiment of the invention will be described with reference to the drawings. In the following description, the terms, “the top, the bottom, the right, and the left”, mean the top, the bottom, the right, and the left of FIG. 1, respectively.

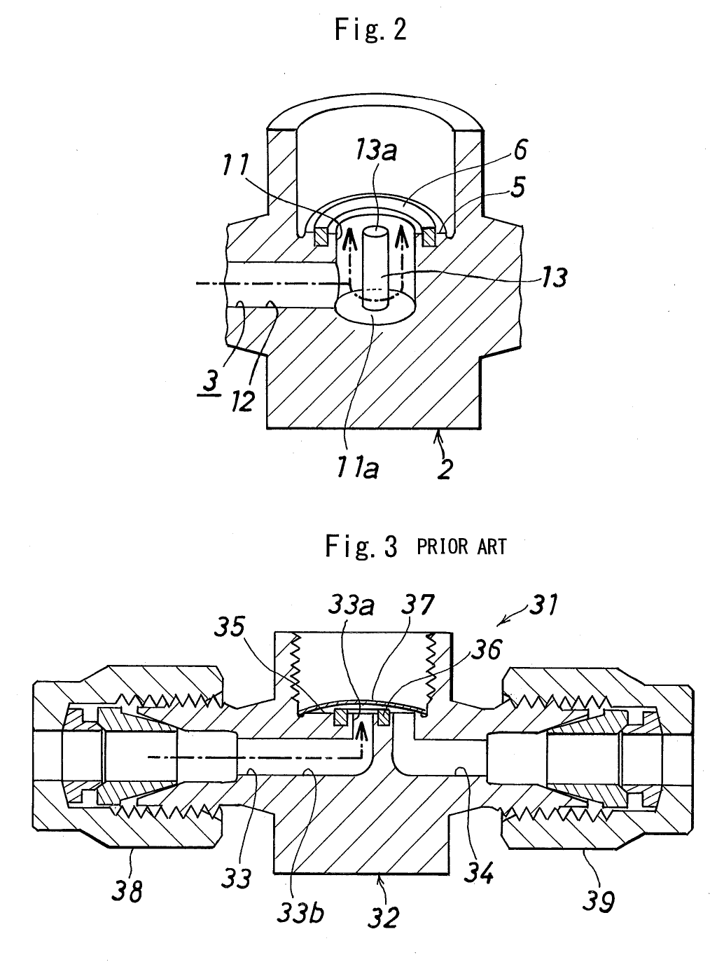

FIG. 1 and FIG. 2 show one embodiment of a diaphragm valve of the invention. A diaphragm valve 1 includes a block-like body 2 having a fluid inflow passage 3, a fluid outflow passage 4, and a recess 5 opening upward, a ring-like sheet 6 disposed on a bottom surface of the recess 5 in the body 2, a diaphragm 7 that opens and closes the fluid inflow passage 3, respectively, when pressed against and spaced apart from the sheet 6, and a drive means (not shown) allowing the diaphragm 7 to be pressed against or spaced apart from the sheet 6.

The body 2 is provided with an inlet-side joint portion 8 and an outlet-side joint portion 9. The joint portions 8 and 9 have first ferrules 8a and 9a, second ferrules 8b and 9b, and tightening nuts 8c and 9c, respectively.

The diaphragm 7 is of a spherical shell shape and under natural conditions it shapes an upward convex arc as shown in FIG. 1. The diaphragm 7 is formed, for example, of a nickel alloy thin plate and formed into a spherical shell shape by cutting a circle out of the thin plate and swelling a center portion of the circle upward. The diaphragm 7 can be formed of a stainless steel thin plate or a laminated body of a stainless steel thin plate and a nickel-cobalt alloy thin plate.

The fluid inflow passage 3 is made up of an inner communication portion 11 extending downward and having an upper end opening that leads to a center portion of the bottom surface of the recess 5 in the body 2 and an outer communication portion 12 extending from side to side and having a right end that leads to the inner communication portion 11 and a left end that forms a fluid inlet.

As is also shown in FIG. 2, the inner communication portion 11 has a column-like protruding portion 13 provided on a lower end surface 11a in an upward protruding shape so as to form a column-like non-passage portion in the inner communication portion 11 and thereby forms a cylindrical-hollow passage.

More specifically, the inner communication portion 11 is of a shape obtained by making the column-like inner communication portion 33a shown in FIG. 3 a non-passage portion and providing a passage so as to surround the non-passage portion. Accordingly, a diameter of the upper end opening of the fluid inflow passage 3 becomes larger than the one in the related art (see FIG. 3) and a diameter of the sheet 6 also becomes larger than the one in the related art (see FIG. 3). Hence, an opening area of the inner communication portion 11 of this embodiment is markedly increased in comparison with an opening area of the column-like inner communication portion 33a in the related art (the equivalent to this opening area is a sectional area of the column-like protruding portion 13).

The outer communication portion 12 is the same column-like passage as the counterpart in the related art.

The fluid outflow passage 4 is made up of a column-like inner communication portion 14 extending diagonally below and having an upper end opening that leads to an outer circumferential portion of the bottom of the recess 5 in the body 2 and a column-like outer communication portion 15 extending from side to side and having a left end that leads to the inner communication portion 14 and a right end that forms a fluid outlet. A height of the sheet 6 (a position of the diaphragm 7) is set higher than the height in the related art (see FIG. 3). Owing to this configuration, an opening area of the inner communication portion 14 is increased in comparison with the opening area in the related art.

An upper surface of the column-like protruding portion 13 formed in the inner communication portion 11 opposes a center portion of a lower surface of the diaphragm 7 with a clearance in between. Hence, when the diaphragm 7 undergoes a considerable deflection, the upper surface (diaphragm support surface) 13a of the column-like protruding portion 13 can receive the center portion of the lower surface of the diaphragm 7. The diaphragm 7 is therefore prevented from undergoing considerable deformation and being damaged. The column-like protruding portion 13 may be formed integrally with the body 2, in other words, the column-like protruding portion 13 may be made of stainless steel that is the same material of which the body 2 is made. Alternatively, the column-like protruding portion 13 may be a column-like body made of resin and provided with a male screw portion which is threaded into a female screw portion provided in the body 2 in a re-attachable manner.

According to the diaphragm valve 1, the opening area of the inner communication portion 11 making up the fluid inflow passage 3 can be increased, that is, the Cv value can be increased without increasing the outer shape of the diaphragm valve 1. Conversely, the diaphragm valve 1 can be made compact while maintaining the Cv value. The Cv value may be increased, for example, by increasing a stroke amount of the diaphragm. Increasing a stroke amount of the diaphragm, however, poses a problem that the life duration is adversely effected. On the contrary, the diaphragm valve 1 can increase the Cv value without exerting such adverse effects.

The drive means (the configuration not shown in the drawings) of the diaphragm valve 1 is formed, for example, of a diaphragm presser that presses the center portion of the diaphragm 7, a stem that allows the diaphragm 7 to be pressed against and spaced apart from the sheet 6 via the diaphragm presser by moving up and down, a piston formed integrally with the stem, a pushing member that pushes the piston downward, an operation air introduction chamber provided on a lower surface of the piston, and so on.

What is claimed is:

1. A diaphragm valve, comprising:
a body provided with a fluid inflow passage, a fluid outflow passage, and a recess opening upward;
a ring-like sheet disposed on a bottom surface of the recess in the body; and
an elastically deformable diaphragm that opens and closes the fluid passages, respectively, when pressed against and spaced apart from the sheet,
wherein:
the fluid inflow passage is made up of an inner communication portion having an upper end opening that leads to a center portion of the bottom surface of the recess in the body and a lower end surface that is closed and an outer communication portion having one end that leads to the inner communication portion and the other end that forms a fluid inlet; and
the inner communication portion has a column-like protruding portion provided on the lower end surface so as to form a column-like non-passage portion in the inner communication portion and thereby forms a cylindrical-hollow passage.

2. The diaphragm valve according to claim 1, wherein:
an upper surface of the column-like protruding portion is a diaphragm support surface that prevents the diaphragm from undergoing a deflection excessively.
